(19) United States
(12) Patent Application Publication
(10) Pub. No.: US 2016/0312908 A1
(43) Pub. Date: Oct. 27, 2016

(54) VALVE WITH A CONNECTING ELEMENT

(71) Applicant: ROBERT BOSCH GmbH, Stuttgart (DE)

(72) Inventors: Jerome Thiery, Strasbourg (FR); Markus Hartinger, Strasbourg (FR); Georg Reeb, Buehl Eisental (DE); Ralph Engelberg, Ditzingen (DE); Andreas lllmann, Weil Der Stadt (DE)

(73) Assignee: Robert Bosch GmbH, Stuttgart (DE)

(21) Appl. No.: 15/106,245

(22) PCT Filed: Dec. 18, 2014
(86) PCT No.: PCT/EP2014/078365

§ 371 Date: Jun. 17, 2016

(30) Foreign Application Priority Data
Dec. 19, 2013 (DE) 10 2013 226 586.7

(51) Int. Cl. F16K 11/065; F16K 31/06; F16K 31/04; F16K 27/04; F16K 3/16

(52) U.S. Cl. CPC F16K 11/0655; F16K 27/044; F16K 3/16; F16K 31/047; F16K 31/0617

(57) ABSTRACT

The invention relates to a flat slide valve (1), in particular a liquid valve, which has at least two flat slides (10a, 10b) and at least two valve plates (15a, 15b). A first flat slide (10a) interacts with a first valve plate (15a), and a second flat slide (10b) interacts with a second valve plate (15b). A first flow channel is released or blocked depending on the position of the first flat slide (10a), and/or a second flow channel is released or blocked depending on the position of the second flat slide (10b). The flat slides (10a, 10b) are connected to each other via a connecting element (30), and the connecting element (30) is substantially arranged in a flat slide valve (1) flow region (35), in particular a common flow region.

### BACKGROUND OF THE INVENTION

The invention relates to a valve. A flat slide valve which has two flat slides and two valve plates, wherein a first flat slide interacts with a first valve plate and a second flat slide interacts with a second valve plate is already known. It is also known that a first flow channel is opened or blocked depending on the position of the first flat slide, and a second flow channel is opened or blocked depending on the position of the second flat slide.

### SUMMARY OF THE INVENTION

The flat slide valve according to the invention has the advantage that the number of components can be minimized. Simplified assembly and, associated with this, cost savings are thus possible. A very compact valve construction is possible. It may be regarded as a further advantage that the actuating forces in a flat slide valve according to the invention are low.

It is particularly advantageous that the flat slide valve has at least three ports, in particular a first port, a second port and a third port. The first and second ports are connected by the first flow channel. The flow channel is arranged between the first and the second port and connects them. The third and the second port are connected by the second flow channel. The second flow channel is arranged between the third and the second port and connects them. It is furthermore advantageous that the flow channels carry liquids or gases, in particular, from one port to another port and vice versa. The position of the flat slide relative to the associated valve seat enables a flow channel to be opened or blocked, in particular allows variation of the flow volume through the flow channel. Thus, the flow volume, in particular the flow rate, can be regulated in a simple manner and/or flow through the flow channel can be prevented.

It should furthermore be regarded as advantageous that the flat slide valve has at least one spring, wherein the spring presses at least one flat slide against at least one valve plate. Through the use of a spring, possible tolerances in the production of the valve plate and of the flat slide are compensated. It should be regarded as a further advantage that a desired blocking of the flow is improved by the pressing of the flat slide against the valve plate. The spring thus increases the sealing effect when the flow channel is blocked, i.e. when flow is to be prevented. Possible leaks resulting in leakage flow can also be minimized.

An advantageous development is that at least one spring is arranged on the pressure side of at least one flat slide. Owing to the pressure difference between the pressure side and the outflow side, forces act on the flat slide. The forces advantageously press the flat slide against the valve plate. By virtue of a spring on the pressure side, the forces due to the medium pressing the flat slide against the valve plate are intensified. It is thus advantageously possible to improve the sealing effect of the flat slide and of the valve plate.

The connecting element acts in a simple manner on the flat slide via the valve plate. The pressure on the flat slide due to the medium to be carried is transmitted to the valve plate. The assembly of the valve can also be simplified. Moreover, the design of the flat slide can be matched to the reduced force, owing to the pressure.

One advantageous embodiment is that an actuator acts on the connecting element. The actuator moves the connecting element and the flat slides connected thereto. The movement of the connecting element is achieved by energizing the actuator. Here, the actuator itself can be designed particularly as an electric motor or as a coil former. The valve can thus be moved in a very simple and inexpensive manner and with the use of a few components. It is furthermore possible to resort to known actuators.

A particularly simple design of the connecting element is achieved if the connecting element comprises a coupling element and a driver element, wherein the driver element interacts with, in particular is connected to, the flat slide. The coupling element and the driver element are arranged substantially at an angle to one another, in particular between 10 degrees and 170 degrees, preferably between 60 and 120 degrees, especially at 90 degrees. Such a design allows advantageous arrangement of the individual components of the flat slide valve. The installation space can thus be reduced. Transmission of the movement from one flat slide to another flat slide is furthermore promoted.

In particular, it is advantageous if the connecting element is arranged on the outflow side of at least one flat slide. The connecting element is situated in the outlet region or in the outlet of the flat slide valve. Thus, the connecting element is situated on the side of the valve member or of the valve seat remote from the pressure. The imposition of a load on the connecting element, especially that owing to the force due to the pressure, by the medium flowing through the valve is minimized. Moreover, the connecting element comes into contact with the medium only when a flow channel is opened. Thus, the use of materials that are appropriate and inexpensive as well as simple to install is possible.

It is advantageous that the flat slide valve has a valve housing, wherein the valve housing comprises at least three valve housing parts, which each have one port. Expenditure for the production of the individual housing parts is minimized through the use of a valve housing consisting of at least three housing parts. In another development of the valve according to the invention, at least two housing parts are designed as common parts. It is thereby possible to simplify production, in particular assembly, and, in association with this, to reduce costs.

It is particularly advantageous that at least one seal is arranged between at least two valve housing parts. In particular, a seal is arranged between the first and the second and/or the second and the third valve housing part. The seal increases the sealing effect between the valve housing parts. The seal furthermore prevents leaks resulting in the medium escaping from the valve housing. The use of the seal makes it possible to simplify production.

It is furthermore advantageous that the flat slide is arranged movably between two valve housing parts, wherein the valve housing parts serve as a guide for the flat slide. No further components serving to guide the flat slide are required. As a result, it is possible to reduce the number of components and assembly steps.

### BRIEF DESCRIPTION OF THE DRAWINGS

Illustrative embodiments of the invention are shown in the drawings and explained in greater detail in the following description, in which:

FIG. 1 shows a flat slide valve having a flow channel,

FIG. 2 shows a flat slide valve having two flow channels,

FIG. 3 shows a first illustrative embodiment of a flat slide valve according to the invention,

FIG. 4 shows another illustrative embodiment of the flat slide valve according to the invention,

FIG. 5 shows the flat slide valve from FIG. 4 with a modified position of the flat slides,

FIG. 6 shows the flat slide valve from FIG. 4 and FIG. 5 with another modified position of the flat slides,

FIG. 7 shows another illustrative embodiment,

FIG. 8 shows a flat slide valve with a direction of flow modified as compared with FIG. 7,

FIG. 9 shows an exploded drawing of the flat slide valve according to FIG. 7, and

FIG. 10 shows another illustrative embodiment of a connecting element.

### DETAILED DESCRIPTION

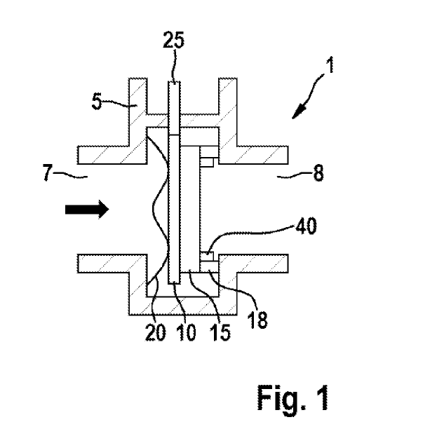

A flat slide valve 1 is shown in FIG. 1. The flat slide valve 1 has a valve housing 5. The valve housing 5 comprises at least one first port 7 and at least one second port 8. In the valve housing 5, between the first port 7 and the second port 8, there are a valve plate 15 and a valve member 10, in particular a flat slide 10. The flat slide 10 interacts with a valve plate 15. In particular, the valve plate 15 and the flat slide 10 have openings. The valve plate 15 is connected positively and/or nonpositively to the valve housing 5 by means of a holding element 18. In particular, the valve housing 5 and the holding element 18 can be designed as a single part. It is furthermore possible, in particular, for an additional seal 40 to improve the sealing effect. The flat slide 10 is mounted so as to be movable relative to the valve plate 15. The flat slide 10 is thus arranged in such a way that it can slide relative to the valve plate 15. A flow channel is opened or blocked depending on the position of the flat slide 10 relative to the valve plate 15. If the openings of the flat slide 10 and the valve plate 15 lie one on top of the other, flow is made possible through the flat slide valve 1. The size of the flow channel depends on the size of the joint opening formed by the openings of the flat slide 10 and of the valve plate 15. It is furthermore also possible, depending on the position of the flat slide 10 relative to the valve plate 15, for an opening to form next to the valve plate 15 or the flat slide 10, which can in turn form a flow channel or a part thereof. If no joint opening is formed, flow is not possible. The flat slide valve 1 is blocked. Any number of openings in the flat slide 10 and the valve plate 15 is possible. A spring 20 presses the flat slide 10 against the valve plate 15 and improves the sealing effect of the flat slide valve 1. The flat slide 10 is connected to a movement element 25. The movement element 25 allows sliding of the flat slide 10 by a device situated outside the valve housing 5. In FIG. 1, by way of example, the inlet is arranged in the region of the first port 7. The pressure side of the flat valve 1 is thus situated on the side of the first port 7. Owing to the pressure difference, the flat slide 10 is pressed onto the valve plate 15. The spring 25 is situated on the pressure side of the flat slide valve 1. The spring 25 intensifies the force due to the pressure difference on the flat slide 10. The arrow in FIG. 1 corresponds to the direction of flow in the flat slide valve 1.

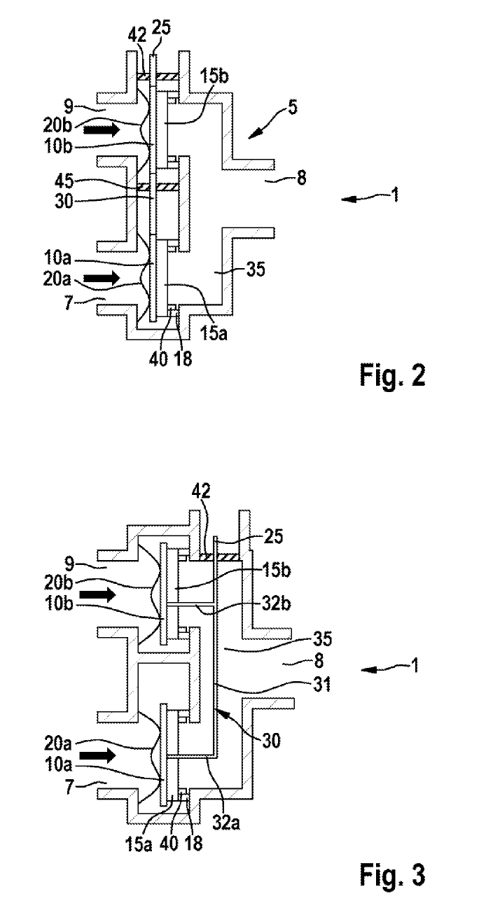

FIG. 2 shows a flat slide valve 1 designed as a changeover valve. The flat slide valve 1 has three ports 7, 8 and 9. The first flat slide 10a and the first valve plate 15a are arranged between the first port 7 and the second port 8. The second flat slide 10b and the second valve plate 15b are arranged between the third port 9 and the second port 8. A first flow channel or, correspondingly, a second flow channel is formed, depending on the position of the flat slides 10a or 10b relative to the respective valve plates 15a or 15b. Two springs 20a or 20b press the respectively associated flat slide 10a or 10b against the valve plate 15a or 15b. Furthermore, the flat slide valve 1 has a common flow region 35. The common flow region 35 is arranged between the flat slides 10a, 10b and the second port 8. The medium flowing through the first port 7 and the medium flowing through the third port 9 flows through the common flow region 35.

If the flat slide valve 1 is used as a liquid valve, the first flat slide 10a and the first valve plate 15a enable and/or block a first flow between the first port 7 and the common flow region 35. The second flat slide 10b and the second valve plate 15b enable and/or block a second flow between the third port 9 and the common flow region 35. The medium in the first flow and the medium in the second flow combine in the common flow region 35. The common flow region 35 is connected to the second port 8 or to part of the second port 8.

For movement of the flat slides 10a and 10b, said slides are connected to a connecting element 30. The connecting element 30 allows simultaneous movement, in particular sliding, of the first flat slide 10a and of the second flat slide 10b. The connecting element 30, in turn, interacts with the movement element 25. A seal 42 prevents one of the media flowing through from escaping from the flat slide valve 1 via the movement element 25. To prevent mixing of the media between the first port 7 and the third port 9, the ports 7, 9 must be sealed off relative to one another. For this purpose, the connecting element 30 passes through an intermediate seal 45. Thus, a complex and expensive solution for sealing off the first port 7 relative to the third port 9 and vice versa is required. Furthermore, the intermediate seal 45 increases the actuating forces of the flat slide valve 1. Moreover, further components are required with the intermediate seal 45.

FIG. 3 shows a first illustrative embodiment of a flat slide valve 1 according to the invention. The flat slide valve 1 has a valve housing 5. A first and a second flat slide 10a and 10b, a first valve plate 15a and a second valve plate 15b, and a first and a second spring 20a and 20b are arranged in the valve housing 5. The first flat slide 10a interacts with the first valve plate 15a and the first spring 20a. The second flat slide 10b interacts with the second valve plate 15b and the second spring 20b. The first valve slide 10a and the first valve plate 15a open or block a flow channel from port 7 to the common flow region 35 and vice versa. The second valve slide 10b and the second valve plate 15b open or block a flow channel from port 9 to the common flow region 35 and vice versa. The springs 20a and 20b are arranged on the pressure side. The pressure side of the flat slides 10a and 10b is preferably associated with ports 7 and 9. In contrast, the outflow side of the respective flat slide 10a or 10b is associated with the common flow region 35. The medium flows via port 7 or 9 into the valve 1 and, via the common flow region 35 and port 8, out of the valve 1.

The connecting element 30 connects the first flat slide 10a to the second flat slide 10b. The connecting element 30 is connected to the movement element 25. In particular, the connecting element 30 and the movement element 25 can be designed as a single part. A seal 42 prevents one of the media flowing through from escaping from the flat slide valve 1 via the movement element 25. The connecting element 30 is situated in the common flow region 35. Here, the connecting element 30 is situated substantially completely in the common flow region 35 of the flat slide valve 1. The connecting element 30 is connected to the first flat slide 10a and the second flat slide 10b and to all further flat slides 10. The connecting element 30 passes through the valve plate 15 to the flat slide 10, in particular the connecting element 30 passes through valve plate 15a to flat slide 10a and through valve plate 15b to flat slide 10b.

The connecting element 30 comprises a coupling element 31 and a driver element 32. The coupling element 31 is connected to at least one driver element 32. In FIG. 3, the connecting element 30 comprises a first driver element 32a, a second driver element 32b and a coupling element 31. The first driver element 32a passes through the first valve plate 15a to flat slide 10a. The first driver element 32a is connected to the first flat slide 10a. The second driver element 32b passes through the second valve plate 15b to the second flat slide 10b. The second driver element 32b is connected to the second flat slide 10b. The driver elements 32a and 32b are arranged at an angle to the coupling element 31. In particular, the driver elements 32a and 32b are arranged at an angle greater than 10 degrees, preferably in the region of 90 degrees, i.e. at right angles to one another. The driver elements 32a and 32b and the coupling element 31 can be designed as a single part. The flat slides 10a, 10b and the driver elements 32a, 32b can also be designed as a single part.

The movement forces of the connecting element 30 have been lowered by the absence of the intermediate seal 45 as compared with the movement forces in the structure shown in FIG. 2. Moreover, fewer components are required.

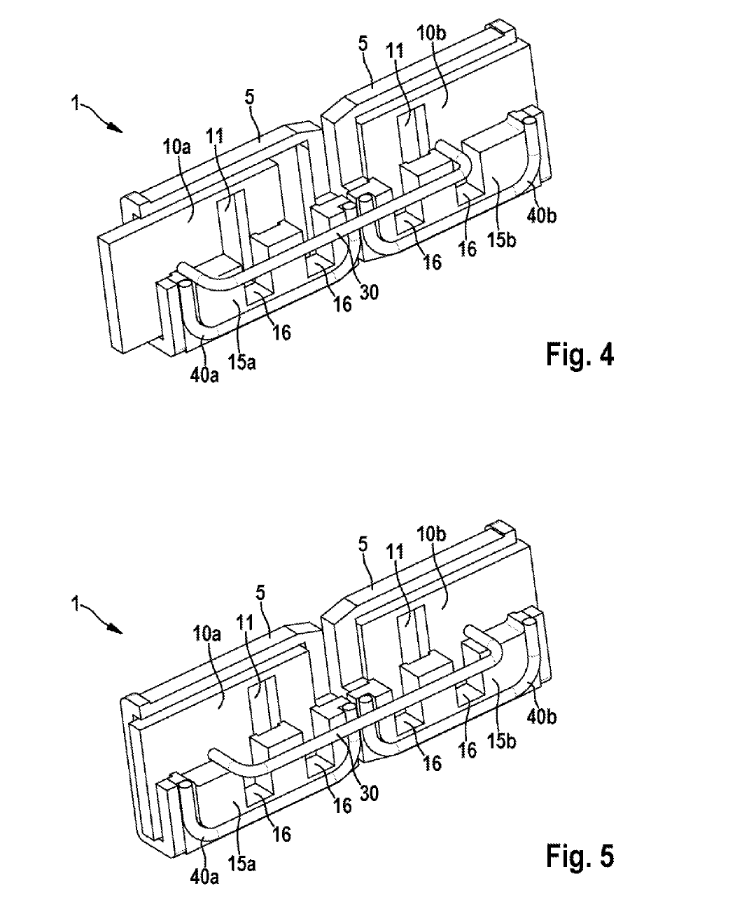

FIG. 4 shows another illustrative embodiment of the flat slide valve 1 according to the invention. In FIG. 4, one part of the valve housing 5 is shown as frames which guide the flat slides 10. To enable the latter to be shown more clearly in FIG. 4, the further housing 5 and ports 7, 8 and 9 have not been shown. There is at least one spring 20 between the valve housing 5 and the flat slide 10. A first flat slide 10a and a first valve plate 15a are furthermore shown. The first flat slide 10a and the first valve plate 15a interact. The flat slide 10a has openings 11, and the valve plate 15a has openings 16. According to FIG. 4, openings 11 and openings 16 are one on top of the other and thus allow flow of a medium through the flat slide valve 1. The superimposed openings 11 and 16 form a flow channel, in particular part of the flow channel. The flow channel comprises the openings in a flat slide 10 or in a valve plate 15. The flow channel is also formed by an opening resulting from a lack of overlap between the valve plate 15 and the flat slide 10. In particular, the medium can be liquid or gaseous. The second flat slide 10b also has openings 11. However, according to FIG. 4 these are offset with respect to the openings 16 in valve plate 15b. Thus, no flow of a medium through the flat slide valve 1 is possible. Flow is blocked or closed. The flow channel is thus shut off.

The first and the second flat slide 10a and 10b are connected positively and nonpositively to one another via a connecting element 30. If one of the two flat slides 10 is moved, the second flat slide 10 is moved, in particular slid, at the same time by means of the connecting element 30. The movement or sliding of the flat slides 10 can be accomplished by means of the movement element 25 or directly by means of the connecting element 30. An additional seal 40a and 40b allows improved sealing of the valve plate 15 with respect to the valve housing 5.

It is possible, in particular, to arrange a spring 20 between the valve housing 5 and the flat slide 10. The spring 20 presses the flat slide 10 against the valve plate 15.

The first flat slide 10a blocks or opens the first flow channel. The first flow channel is situated between the first port (not shown in FIG. 4 for greater clarity) and the common flow region (not shown in FIG. 4 for the sake of greater clarity). The second flat slide 10b blocks or opens the second flow channel. The second flow channel connects the third port (not shown in FIG. 4 for the sake of greater clarity) to the common flow region (not shown in FIG. 4 for the sake of greater clarity). The connecting element 30 is arranged in the common flow region.

The flat slide valve 1 from FIG. 5 corresponds to the flat slide valve 1 from FIG. 4 with a modified position of the flat slides 10a and 10b relative to the valve plates 15a and 15b. The openings 11 in the flat slides 10a and 10b are covered by the valve plates 15a and 15b. The openings 16 in the valve plates 15a and 15b are covered by the flat slides 10a and 10b. No flow is therefore possible through the flat slide valve 1. The flow channel is blocked. There is no channel to allow flow through the flat slide valve 1.

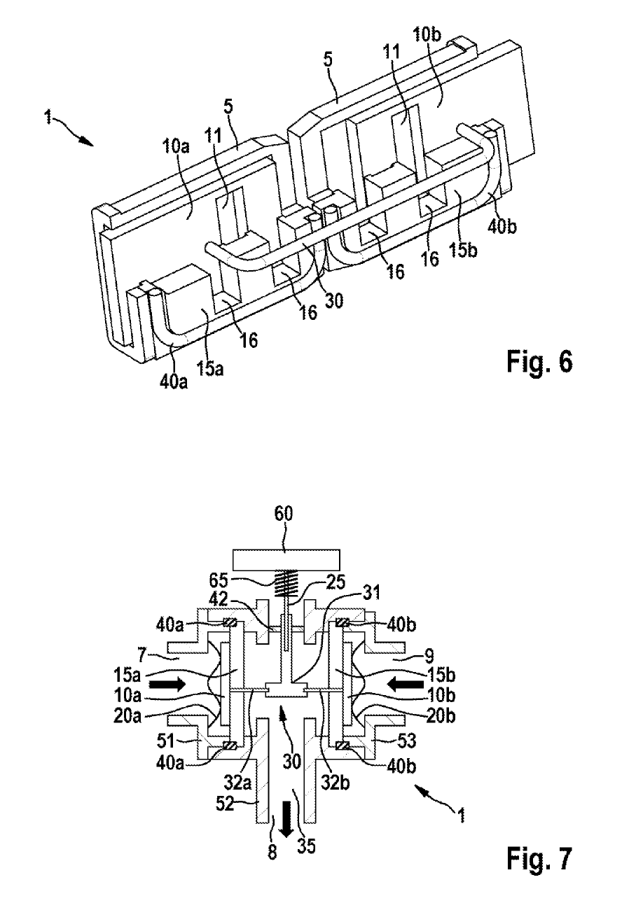

FIG. 6 shows the flat slide valve 1 from FIG. 4 and FIG. 5 with another modified position of the flat slides 10a and 10b relative to the valve plates 15a and 15b. The reference signs in FIGS. 4, 5 and 6 are identical. In FIG. 6, the openings 11 in the second flat slide 10b, together with the openings in the second valve plate 15b, form a flow channel through the valve 1. For example, each flat slide 10a and 10b is assigned a separate port, and the connecting element 30 is situated in a common flow region 35. For example, the first flat slide 10a is assigned to the first port and the second flat slide 10b is assigned to the second port. According to the position of the flat slides 10a and 10b from FIG. 4, a medium can flow between the common flow region and the first port and vice versa. According to the position of the flat slides 10a and 10b from FIG. 5, a medium cannot flow between the common flow region and the first port or the third port. According to the position of the flat slides 10a and 10b from FIG. 6, a medium can flow between the common flow region and the second port and vice versa.

Another illustrative embodiment of a flat slide valve 1 according to the invention is shown in FIG. 7. The flat slide valve 1 has a valve housing 5. Once again, the valve housing 5 has a plurality of valve housing parts 51, 52 and 53. The first valve housing part 51 comprises a first port 7. The second valve housing part 52 comprises a common current and/or flow region 35 and a second port 8. The common flow region 35 is connected to the second port 8. In particular, the first and the second valve housing part 51 and 52 are fitted together, adhesively bonded, welded or clipped. Valve plate 15a, flat slide 10a, spring 20a and seal 40a are arranged between the first housing part 51 and the second housing part 52. Valve plate 15a rests against the second housing part 52. Seal 40a is arranged between the second housing part 52, the first housing part 51 and valve plate 15a. Seal 40a prevents possible leaks between the first port 7 and the environment or between the first port 7 and the common flow region 35. Flat slide 10a is pushed, in particular pressed, against valve plate 15a by means of spring 20a. Respective openings are formed in flat slide 10a and valve plate 15a, allowing or blocking flow depending on their position relative to one another.

To simplify production, the third valve housing part 53 can be of identical design to the first valve housing part 51, the operation of the two valve housing parts, in particular, being identical. The third valve housing part 53 comprises a third port 9. In particular, the third and the second housing part 53 and 52 are fitted together, adhesively bonded, welded or clipped. Valve plate 15b, flat slide 10b, spring 20b and seal 40b are arranged between the third housing part 53 and the second housing part 52. Valve plate 15b rests against the second housing part 52. Seal 40b is arranged between the second housing part 52, the third housing part 51 and valve plate 15b. Seal 40b prevents possible leaks between the third port 9 and the environment or between the third port 9 and the common flow region 35. Flat slide 10b is pushed, in particular pressed, against valve plate 15b by means of spring 20b. Respective openings are formed in flat slide 10b and valve plate 15b, allowing or blocking flow depending on their position relative to one another.

The operation of the flat slide 10b, the valve plate 15b, the spring 20b and the seal 40b of the third valve housing 53 is therefore identical with that of the flat slide 10a, the valve plate 15a, the spring 20a and the seal 40a of the first valve housing part 51.

The flat slides 10a and 10b are furthermore mounted movably, in particular slidably. By virtue of the slidability, it is possible to move the openings in the flat slide 10 over the openings in the valve plate and to allow flow. However, it is also possible for the openings in the valve plate 15 to be covered by the openings in the flat slide 10 and vice versa. In this case, flow of a medium through the valve plate region 15 and the flat slide region 10 is prevented or blocked. It is furthermore possible to open a flow channel through a lack of overlap between the valve plate 15 and the flat slide 10. In particular, the flow channel can be made up of any number of channels or openings formed as a flat slide 10 interacts with a valve plate 15.

The flat slides 10a and 10b are connected to the connecting element 30. The connecting element 30 comprises a coupling element 31 and at least one driver element 32. The driver element 32 connects the flat slide 10 to the coupling element 31. Here, the driver element 32 passes through the valve plate 15. In FIG. 7, a first driver element 32a is connected to the first flat slide 10a. A second driver element 32b is connected to the second flat slide 10b. The driver elements 32a and 32b are arranged on the same axis. The driver elements 32a and 32b are connected to the coupling element 31 at an angle, in particular at right angles, as shown in the figure. The driver elements 32a and 32b can be embodied as a single part.

The connecting element 30 is situated substantially, in particular completely, in a region of the valve 1 through which there is a flow. The connecting element 30 is situated in the common flow region 35 of the valve 1. The medium which flows through the first port 7 and the medium which flows through the second port 8 and through the third port 9 thus flows around the connecting element 30. The connecting element 30 is connected to a movement element 25. The movement element 25 is moved by an actuator 60. It is possible, in particular, for the connecting element 30 and the movement element 25 to be designed as a single part.

The actuator 60 can be designed as an electric motor or as an electromagnet. An attraction element is attracted by energizing the actuator 60, e.g. an electromagnet. The attraction element is connected to the movement element 25. In particular, the attraction element and the movement element 25 are embodied as a single part. Thus, when the actuator 60 is energized, the connecting element 30 and hence the flat slides 10a and 10b are moved. A return spring 65 moves the connecting element 30 and the flat slides 10a and 10b connected thereto back into an initial position.

If the actuator 60 is designed as an electric motor, the motor begins to rotate when energized. The rotation of the electric motor is converted into a longitudinal movement by a spindle. The longitudinal movement can be transmitted, in turn, to the connecting element 30 by the movement element 25.

According to another illustrative embodiment, the actuator 60 can be designed as an electric motor. The connecting element 30 acts as a spindle, in the thread of which the driver elements 32a and 32b engage. Rotation of the electric motor causes movement of the driver elements 32a and 32b, in particular in the longitudinal direction.

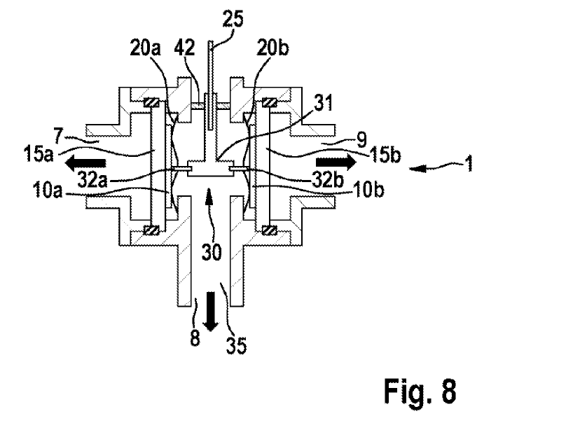

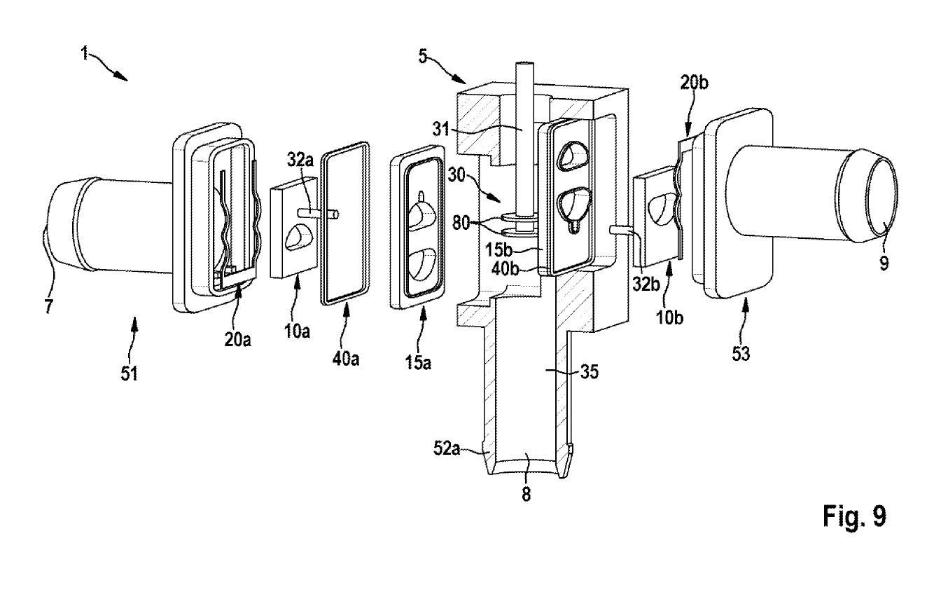

In FIG. 8, the directions of flow of the medium through the valve are different from the directions of flow in FIG. 7. In the flat slide valve 1 in FIG. 7, the inlets correspond to ports 7 and 9, and the outlet corresponds to port 8. In FIG. 8, the inlet corresponds to port 8, and the outlets correspond to ports 7 and 9. In the valve 1 shown in FIG. 8, the arrangement of the flat slides 10, of the valve plate 15 and of the spring 20 have been changed. In FIG. 7, the springs 20a and 20b are situated in the inlet region or pressure region, i.e. in the region of ports 7 and 9 of the flat slide valve 1. Since the inlet region is situated in the common flow region 35 in FIG. 8, the springs 20a and 20b are associated with this region. The springs 20 press the flat slide 10 against the valve plate 15. The springs 20 are assisted by the force due to the pressure of the medium in the inlet channel. The connecting element 30 is situated in the common flow region 35. The operation and construction of the connecting element 30 are identical with the operation of the connecting element in FIG. 7.

An exploded view of the flat slide valve 1 according to FIG. 7 is shown in FIG. 9. The valve housing 5 comprises a first housing part 51, a second housing part 52 and a third housing part 53. Spring 20a, flat slide 10a, seal 40a and valve plate 15a are furthermore arranged in the region of the first housing part 51 and the second housing part 52. Spring 20b, flat slide 10b, seal 40b and valve plate 15b are arranged between the second housing part 52 and the third housing part 53. The operation and construction correspond to those in FIG. 7. The connecting element 30 comprises a coupling element 31. In an end region, the coupling element 31 has two lips 80. In particular, the coupling element 31 and the lips 80 are designed as a single part. The two lips 80 serve to guide the driver elements 32a and 32b. By means of the two lips 80, the coupling element 31 is connected positively to at least one of the driver elements 32a and/or 32b. Thus, the flat slides 10a and 10b can be moved by means of the connecting element 30. The flat slides 10 can be designed as a single part with the drivers 32.

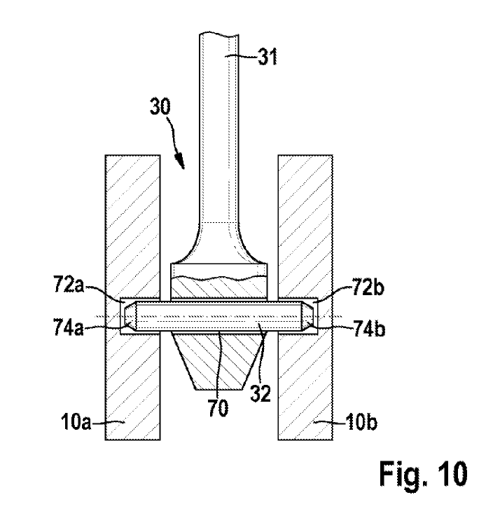

Another illustrative embodiment of a connecting element 30 for a flat slide valve 1 according to the invention is shown in FIG. 10. The connecting element 30 can be used in a flat slide valve 1 according to the invention. The connecting element 30 has a driver element 32 and a coupling element 31. The coupling element 31 has a fastening channel 70. In particular, the driver element 32 is designed as a pin. The driver element 32 has two ends 74a, 74b. In particular, the driver element 32 is fitted into the fastening channel 70 at a fixed angle and in a centered manner. The driver element 32 according to FIG. 10 interacts with the first flat slide 10a and the second flat slide 10b. For this purpose, the flat slides 10a and 10b each have a receiving element 72a, 72b, in particular a bore, a depression or a groove. One end 74a of the driver element 32 engages in receiving element 72a, and another end 74b of the driver element 32 engages in receiving element 72b. The driver element 32 and the flat slides 10a, 10b interact with one another or are connected to one another, in particular by means of a loose fit or a positive fit. The coupling element 31 transmits the movement of the actuator 60 to the first flat slide 10a and the second flat slide 10b via the driver element 32. The actuator 60 acts via the coupling element 31 and the driver element 32 on the flat slides 10a and 10b.

The construction according to FIG. 10 can be used especially in a flat slide valve 1 according to FIGS. 7 to 9. For greater ease of comprehension, further components, in particular the housing 5, ports 7, 8 and 9 etc., shown in FIGS. 7 to 9 are not shown in FIG. 10.

According to another illustrative embodiment, the actuator 60 acts directly on a flat slide 10a, 10b. For this purpose, the flat slide 10a, 10b has the attraction element or comprises the attraction element. In particular, the flat slide 10a, 10b can be at least partially composed of material which can be attracted or repelled by the magnetic force of the actuator 60. The force can furthermore be transmitted from the actuator 60 to one of the flat slides 10 via spindles, gearwheels etc. Thus, the force of the actuator 60 acts directly on the flat slides 10a and/or 10b. The connecting element 30 transmits the movement of the first flat slide 10a to the second flat slide 10b and/or vice versa. The direct exertion of force on one or both flat slides 10a, 10b by the actuator 60 promotes uniform distribution of force without a lever arm.

Any number of flat slides 10, valve plates 15, ports and/or springs 20 can be added to the flat slide valve 1.

1. A flat slide valve (1), which has at least two flat slides (10a, 10b) and at least two valve plates (15a, 15b), wherein a first flat slide (10a) interacts with a first valve plate (15a) and a second flat slide (10b) interacts with a second valve plate (15b), wherein a flow channel is opened or blocked depending on the position of one of the first flat slide (10a) and the second flat slide (10b), characterized in that the flat slides (10a, 10b) are connected to each other via a connecting element (30), and the connecting element (30) is arranged substantially in a flow region (35) of the flat slide valve (1).

2. The flat slide valve (1) as claimed in claim 1, wherein a first flow channel is opened or blocked depending on the position of the first flat slide (10a), and/or a second flow channel is opened or blocked depending on the position of the second flat slide (10b), characterized in that the flat slide valve (1) has at least three ports (7, 8, 9), wherein the first flow channel connects a first port (7) and a second port (8), and the second flow channel connects a second port (8) and a third port (9).

3. The flat slide valve (1) as claimed in claim 1, characterized in that the flat slide valve (1) has at least one spring (20), wherein the spring (20) presses at least one flat slide (10a, 10b) against at least one valve plate (15a, 15b).

4. The flat slide valve (1) as claimed in claim 2, characterized in that at least one spring (20) is arranged on a pressure side of at least one flat slide (1).

5. The flat slide valve (1) as claimed in claim 1, characterized in that the connecting element (30) acts on the flat slide (10a, 10b) via the valve plate (15a, 15b).

6. The flat slide valve (1) as claimed in claim 1, characterized in that an actuator (60) acts on the connecting element (30).

7. The flat slide valve (1) as claimed in claim 1, characterized in that the connecting element (30) comprises a coupling element (31) and a driver element (32), wherein the driver element (32) interacts with at least one flat slide (10a, 10b) and the coupling element (31) and the driver element (32) are arranged substantially at an angle to one another.

8. The flat slide valve (1) as claimed in claim 1, characterized in that the connecting element (30) is arranged on an outflow side of at least one flat slide (10a, 10b).

9. The flat slide valve (1) as claimed in claim 1, characterized in that the flat slide valve (1) has a valve housing (5), wherein the valve housing (5) comprises at least three valve housing parts (51, 52, 53), which each have one port (7, 8, 9).

10. The flat slide valve (1) as claimed in claim 9, characterized in that at least one seal (40) is arranged between at least two valve housing parts (51, 52, 53).

11. The flat slide valve (1) as claimed in claim 9, characterized in that the flat slide (10a, 10b) is arranged movably between the two valve housing parts (51, 52, 53).

12. The flat slide valve (1) as claimed in claim 1, wherein the valve (1) is a liquid valve, wherein a first flow channel is opened or blocked depending on the position of the first flat slide (10a), and/or a second flow channel is opened or blocked depending on the position of the second flat slide (10b), and wherein the connecting element (30) is arranged substantially in a common flow region (35) of the flat slide valve (1).

13. The flat slide valve (1) as claimed in claim 1, characterized in that an actuator (60), wherein the actuator is a coil former or an electric motor, acts on the connecting element (30).

14. The flat slide valve (1) as claimed in claim 1, characterized in that an actuator (60) moves the connecting element (30).

15. The flat slide valve (1) as claimed in claim 1, characterized in that an actuator (60) slides the connecting element (30).

16. The flat slide valve (1) as claimed in claim 1, characterized in that the connecting element (30) comprises a coupling element (31) and a driver element (32), wherein the driver element (32) is connected to at least one flat slide (10a, 10b) and the coupling element (31) and the driver element (32) are arranged substantially at an angle to one another.
